(19) United States
(12) Patent Application Publication
(10) Pub. No.: US 2026/0006417 A1
(43) Pub. Date: Jan. 1, 2026

(54) TECHNIQUES FOR ENHANCED DATA INTEGRITY IN MOBILE ENVIRONMENTS

(71) Applicant: Ergotron, Inc., St. Paul, MN (US)

(72) Inventor: Arlow Farrell, Smyrna, TN (US)

(21) Appl. No.: 19/208,315

(22) Filed: May 14, 2025

Related U.S. Application Data
(60) Provisional application No. 63/664,597, filed on Jun. 26, 2024.

(51) Int. Cl. H04W 4/50; H04L 43/0811; H04L 67/12; H04W 4/80; H04W 84/18

(52) U.S. Cl. CPC H04W 4/50; H04L 43/0811; H04L 67/12; H04W 4/80; H04W 84/18

(57) ABSTRACT

Techniques for equipping mobile equipment with two different types of wireless communication devices, one of which is part of a mesh network that may serve as a backup pathway to route data to the internet. The mobile equipment, e.g., mobile carts, may dynamically switch to a mesh network when Wi-Fi connectivity fails or is weak. This dual-network approach enhances the reliability of data transmission, reduces the dependency on a single type of network, and ensures continuous operation, which may be important in certain environments, such as in a healthcare setting.

### CLAIM OF PRIORITY

This application claims the benefit of priority to U.S. Provisional Application Ser. No. 63/664,597, titled “TECHNIQUES FOR ENHANCED DATA INTEGRITY IN MOBILE ENVIRONMENTS” to Arlow Farrell, filed Jun. 26, 2024, which is incorporated by reference herein in its entirety.

### FIELD OF THE DISCLOSURE

This document pertains generally, but not by way of limitation, to asset monitoring and more particularly to wireless communication between assets.

### BACKGROUND

Mesh networks are distinguished by their decentralized topology where each node connects directly to multiple other nodes, allowing data to be transmitted across various paths. This topology enhances the reliability and redundancy of the network, as it may reconfigure itself automatically in the event of node failures or disruptions, ensuring continuous service. The scalability of mesh networks is particularly beneficial for large-scale implementations, as new nodes may be added seamlessly, maintaining operational stability even with the failure of individual nodes.

Bluetooth Low Energy (BLE) is a technology that complements mesh networks by providing low-power, cost-effective communication over comparable ranges to classic Bluetooth. Adapted for mesh networking, BLE is ideal for the Internet of Things (IOT), supporting efficient connectivity among numerous devices. BLE mesh networks are optimized for low energy use, which is important for devices requiring long battery life and are robust enough to support thousands of nodes.

The integration of BLE with mesh networking technology marks a significant advancement in network design, offering enhanced scalability, reliability, and efficiency. This combination is particularly effective in environments demanding high connectivity and energy efficiency, such as in smart lighting systems and comprehensive home automation networks. BLE's widespread adoption and support across many consumer electronics further facilitate its integration into diverse markets, making it a cornerstone technology in modern IoT ecosystems.

### SUMMARY OF THE DISCLOSURE

This disclosure describes various techniques for equipping mobile equipment with two different types of wireless communication devices, one of which is part of a mesh network that may serve as a backup pathway to route data to the internet. The mobile equipment, e.g., mobile carts, may dynamically switch to a mesh network when Wi-Fi connectivity fails or is weak. This dual-network approach enhances the reliability of data transmission, reduces the dependency on a single type of network, and ensures continuous operation, which may be important in certain environments, such as in a healthcare setting.

In some aspects, this disclosure is directed to a mobile cart for use in a hospital environment, the mobile cart comprising: a first wireless communication device including a processor, the first wireless communication device configured for transmitting first data using a first communication protocol to a remote computing device using a wireless communications network, wherein the processor is configured for: transmitting, via the wireless communications network, the first data to the remote computing device when a connectivity status of the wireless communications network is above a threshold; and transmitting the first data to a second wireless communication device when the connectivity status is below the threshold; and the second wireless communication device includes a processor configured for: receiving the first data from the first wireless communication device; and transmitting the first data, using a second communication protocol different than the first communication protocol, to a third wireless communication device, wherein the second wireless communication device and the third wireless communication device form part of a local network.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a simplified block diagram of an example of a system that may implement various techniques of this disclosure.

FIG. 2 depicts an example of a system that includes the mobile devices of FIG. 1.

FIG. 3 depicts a sequence diagram of an example of a redundancy technique to ensure reliable data transmission.

FIG. 4 is a flow diagram of an example of a method of operating a mobile cart in a hospital environment, where the mobile cart includes a first wireless communication device including a processor, the first wireless communication device configured for transmitting first data using a first communication protocol to a remote computing device using a wireless communications network.

FIG. 5 is a perspective view of an example of a charging station that may implement various techniques of this disclosure.

### DETAILED DESCRIPTION

The present inventor has recognized the need for maintaining reliable data transmission to the internet in environments where Wi-Fi connectivity is often unstable or unavailable, such as in healthcare settings. The present inventor has recognized that a mesh network may serve as a backup data pathway between mobile equipment, such as mobile carts, mobile cabinets, mobile desks, and mobile workstations, such as in a healthcare setting.

This disclosure describes various techniques for equipping mobile equipment with two different types of wireless communication devices, one of which is part of a mesh network that may serve as a backup pathway to route data to the internet. The mobile equipment, e.g., mobile carts, may dynamically switch to a mesh network when Wi-Fi connectivity fails or is weak. The techniques are particularly useful for environments with mobile units that require constant internet connectivity to transmit important data, e.g., operational data associated with components of the mobile cart. These techniques intelligently route data to a node in the mesh network that is on a mobile cart that is connected to the internet, ensuring that data reaches the cloud without interruption. This dual-network approach enhances the reliability of data transmission, reduces the dependency on a single type of network, and ensures continuous operation, which may be important in certain environments, such as in a healthcare setting.

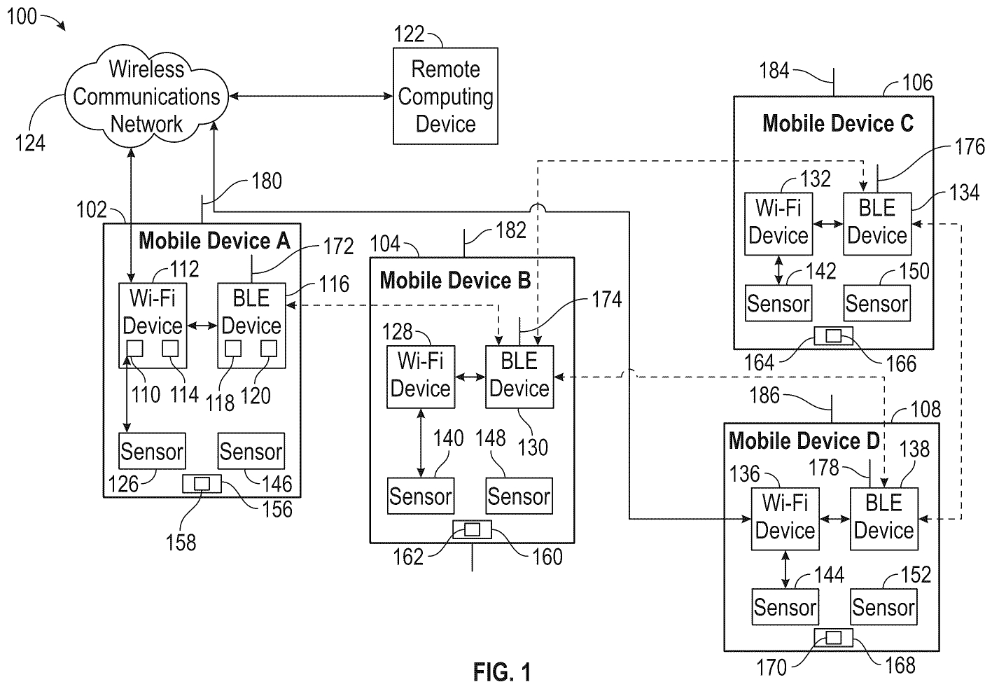

FIG. 1 is a simplified block diagram of an example of a system 100 that may implement various techniques of this disclosure. The system 100 includes various mobile devices, such as mobile carts, mobile cabinets, mobile desks, mobile workstations, and other types of mobile equipment, such as for use in a hospital environment, school environment, warehouse, retail environment, office space, etc. In the non-limiting example shown in FIG. 1, four mobile devices are shown, namely mobile device A 102, mobile device B 104, mobile device C 106, and mobile device D 108. In other examples, there may be more than four mobile devices or fewer than four mobile devices.

The mobile device A 102, e.g., a mobile cart, includes a first wireless communication device, e.g., Wi-Fi device 110 including a processor 112 and a memory 114, and a second wireless communication device, e.g., Bluetooth Low Energy (BLE) device, namely BLE device 116 including a processor 118 and a memory 120. The Wi-Fi device 110 and the BLE device 116 are configured to communicate with one another, such as via Universal Asynchronous Receiver-Transmitter (UART). An example of a Wi-Fi device 110 is a Raspberry Wi-Fi device and an example of a BLE device 116 is the BLE device series of BLE devices available from Nordic Semiconductor.

The Wi-Fi device 110 is configured for transmitting data, e.g., analytics data, using a first communication protocol, e.g., the IEEE 802.11 family of standards for wireless communication, to a remote computing device 122, e.g., one or more remote computing devices, using a wireless communications network 124, e.g., the Internet. In some examples, the operational data includes battery data and telemetry data. The BLE device 116 is configured for transmitting data using a second communication protocol different than the first communication protocol, such as defined by the Bluetooth Special Interest Group (Bluetooth SIG) (https://www.bluetooth.com/specifications/specs/mesh-profile-1-0-1/, which is incorporated herein by reference in its entirety).

The mobile device A 102 further includes a sensor 126 configured to detect a strength of a signal associated with the wireless communications network 124. The sensor 126 is in communication with the processor 112 of the Wi-Fi device 110. Based on the strength of the signal associated with the wireless communications network 124, the processor 112 may determine a connectivity status of the wireless communications network to the Wi-Fi device 110. For example, the processor 112 may compare the strength of the signal to a threshold.

In some examples, the processor of a Wi-Fi device of a mobile device is configured for transmitting the connectivity status to the BLE device of the mobile device. For example, the processor 112 of the Wi-Fi device 110 is configured for transmitting the connectivity status of the Wi-Fi device 110 to the BLE device 116 of the mobile device A 102. The BLE device may store the connectivity status of the corresponding Wi-Fi device in the mobile device in a dynamic table or other data structure.

Each of the other mobile devices in the system 100, namely the mobile device B 104, the mobile device C 106, and the mobile device D 108, may be configured similarly to the mobile device A 102 with similar wireless communication devices. The mobile device B 104 includes, for example, a Wi-Fi device 128 and a BLE device 130 (with corresponding processors and memories), and a sensor 140 similar to the sensor 126 of the mobile device A 102. The mobile device C 106 includes, for example, a Wi-Fi device 132 and a BLE device 134 (with corresponding processors and memories), and a sensor 142 similar to the sensor 126 of mobile device A 102. The mobile device D 108 includes, for example, a Wi-Fi device 136 and a BLE device 138 (with corresponding processors and memories), and a sensor 144 similar to the 126 of the mobile device A 102.

In the non-limiting example of FIG. 1, two mobile devices, namely the mobile device A 102 and the mobile device C 106, are shown connected to the wireless communications network 124. The other two mobile devices (the mobile device B 104 and the mobile device D 108) are not connected to the wireless communications network 124, e.g., they may not be configured or may be out of range.

In some examples, the BLE device 116, the BLE device 130, the BLE device 134, and the BLE device 138 form a local network, such as a mesh network. In a mesh network configuration, each BLE device is considered a node in the mesh network.

The processor of a Wi-Fi device, such as the processor 112 of the Wi-Fi device 110 of the mobile device A 102 is configured for transmitting, via the wireless communications network 124, the data to the remote computing device 122 when the connectivity status of the wireless communications network 124 is above a threshold. In other words, when the Wi-Fi signal strength is sufficiently strong, then the mobile device, such as the mobile device A 102, is configured for transmitting the data to the remote computing device 122.

However, when the connectivity status of the wireless communications network is below the threshold, the mobile device is configured for transmitting the data to a second wireless communication device of the mobile device, e.g., to the BLE device 116 using UART, when the connectivity status is below the threshold.

In accordance with this disclosure, each BLE device in the local network, e.g., a mesh network, maintains in its corresponding memory a dynamic table or other data structure that stores the connectivity status of other devices within the mesh network, which may be data representing the active devices in the mesh network. The table is continuously updated to reflect changes in the mesh network, such as BLE devices going offline, coming back online, and being added to or removed from the mesh network. For example, the BLE device 116 of the mobile device A 102 maintains a dynamic table that indicates that it is connected to the BLE device 130, the BLE device 134, and the BLE device 138 via the mesh network.

In addition, each BLE device in the network maintains a dynamic table that stores which BLE devices are associated with Wi-Fi devices that have a connectivity status that indicates they are connected to the wireless communications network 124. For example, the BLE device 116 maintains a dynamic table indicating that the Wi-Fi device 110 of the mobile device A 102 and the Wi-Fi device 132 of the mobile device C 106 are connected to the wireless communications network 124.

When a Wi-Fi device, e.g., the Wi-Fi device 110 of the mobile device A 102, attempts to send data to the wireless communications network 124 but finds itself out of Wi-Fi range, the Wi-Fi device transmits the data to the corresponding BLE device in the mobile device, e.g., the BLE device 116 of the mobile device A 102. The BLE device consults its table to determine the nearest online BLE device, such as based on a connectivity status. The connectivity status may be determined by signal strength, for example, such as by using a sensor of the mobile device, such as the sensor 126 of the mobile device A 102 or a similar sensor. The processor 118 of the BLE device 116 is configured for receiving the data from the Wi-Fi device 110 and transmitting the data to another BLE device in the mesh network. In the example shown in FIG. 1, the BLE device 116 is in communication with the BLE device 130 of the mobile device B 104.

The BLE device 130 determines from the table stored in its memory that it is in communication with the BLE device 134 of the mobile device C 106 and the BLE device 138 of the mobile device D 108. The BLE device 130 also determines from the table stored in its memory that the BLE device 134 of the mobile device C 106 is associated with a Wi-Fi device that has a connectivity status indicating that it is in communication with the wireless communications network 124. As seen in FIG. 1, the Wi-Fi device 132 of mobile device C 106 is in communication with the wireless communications network 124 but the Wi-Fi device 136 of the mobile device D 108 is not in communication with the wireless communications network 124.

In some examples, the BLE device 130 transmits the data (originally from the Wi-Fi device 110 of mobile device A 102) to both the BLE device 134 of the mobile device C 106 and to the BLE device 138 of the mobile device D 108. In such an example, the BLE device 134 transmits the data to the Wi-Fi device 132 of the mobile device C 106, the Wi-Fi device 132 transmits the data to the remote computing device 122 via the wireless communications network 124, and the BLE device 138 of the mobile device D 108 discards the data because the Wi-Fi device 136 is not in communication with the wireless communications network 124. In other examples, the BLE device 130 transmits the data to the BLE device 134 of the mobile device C 106 and not to the BLE device 138 of the mobile device D 108 because the Wi-Fi device 136 is not in communication with the wireless communications network 124.

In summary, when a Wi-Fi device goes offline, it will send its analytics data to its BLE device, such as over UART. The BLE device then sends a message with the analytics data through the local network, e.g., mesh network, to the closest online mobile device. A mobile device that is not the intended destination will forward the message with the analytics data to the surrounding nodes in the mesh network. Once the message with the analytics data reaches its destination mobile device, the BLE device associated with that destination mobile device sends the message to its corresponding Wi-Fi device, such as over UART. The BLE device associated with that destination mobile device sends an acknowledgment back to the original BLE device to let it know that the message was successfully received. The Wi-Fi device of the mobile device on the destination mobile device transmits the message with the analytics data to one or more remote computing devices.

In some examples, a mobile device of FIG. 1 includes one or more additional sensors. Additional data collected through the additional sensor(s) may be transmitted to the remote computing device 122 through the local network and/or the wireless communications network for further processing to create maintenance alerts, operation and usage alerts, and the like. For example, the mobile device A 102 may include one or more additional sensors 146. Examples of additional sensors include a temperature sensor, an IMU 6D/9D (inertial measurement unit, high accuracy accelerometer/gyroscope) to track vibration, movement, tip, etc., LiDAR (Light Detection and Ranging, laser scanning), air pressure sensor, humidity sensor, magnetometer, air quality sensor, voltmeter, ammeter, thermometer, vibration sensor, proximity sensor, NFC reader, RFID reader, ambient light sensor, air quality sensor, a radioactivity sensor, a radiation sensor, a lighting sensor, a magnetic field sensor, a sit-stand worksurface height sensor, a height adjustment cycle sensor, a vibration sensor, a power on/off state sensor, a voltage sensor, a current sensor, a battery cycle sensor, a drawer state sensor, a contact sensor, a barometric pressure sensor, a fault status sensor, a wireless networking operational sensor, odometer, decibel meter, oxygen sensor, motion sensor, pressure sensor, and ultrasonic sensor. One or more additional mobile devices of FIG. 1 may include such additional sensor(s), such as sensors 148, 150, and 152 of the mobile device B 104, the mobile device C 106, and the mobile device D 108, respectively.

In some examples, the BLE mesh network is used for real-time location services. A BLE mesh network used for real-time location services offers several desirable advantages. First, it enables precise and efficient tracking of devices within a network, which is desirable in environments such as hospitals, warehouses, and large retail spaces where knowing the exact location of assets may significantly enhance operational efficiency. Second, the mesh network's ability to self-heal and reconfigure automatically ensures continuous service even if individual nodes fail or are obstructed, providing robustness and reliability. Additionally, BLE mesh networks are cost-effective as they use low-energy protocols, which extend the battery life of the tracking devices and reduce maintenance costs. Lastly, the scalability of BLE mesh networks allows for the easy addition of more nodes, making it an adaptable solution that may grow with the needs of the business or facility.

In some examples, the mobile devices include hot-swappable batteries. In some such examples, BLE antennas are coupled with the hot-swappable batteries and are configured to permit the collection of data (location, cycle count, etc.) on batteries coupled with the mobile device and, in some examples, batteries outside the mobile device. In the example shown in FIG. 1, the mobile device A 102 includes a hot-swappable battery 156 having a BLE antenna 158. The mobile device B 104 includes a hot-swappable battery 160 having a BLE antenna 162. The mobile device C 106 includes a hot-swappable battery 164 having a BLE antenna 166. The mobile device D 108 includes a hot-swappable battery 168 having a BLE antenna 170. Each BLE device may also include a BLE antenna, shown as BLE antennas 172-178 corresponding with mobile devices A-D, respectively, for corresponding with one another, the hot-swappable batteries, and/or other devices, including a charging station. As described in more detail below, the hot-swappable batteries may transmit battery data that may include, but is not limited to, battery capacity and usage status. Each of the mobile devices A-D may include corresponding antennas 180-186, such as for transmitting and receiving Wi-Fi signals.

The techniques of FIG. 1 optimize data transmission paths based on real-time network conditions and enhance the overall robustness and efficiency of the network by ensuring that data can always find a path to the Internet.

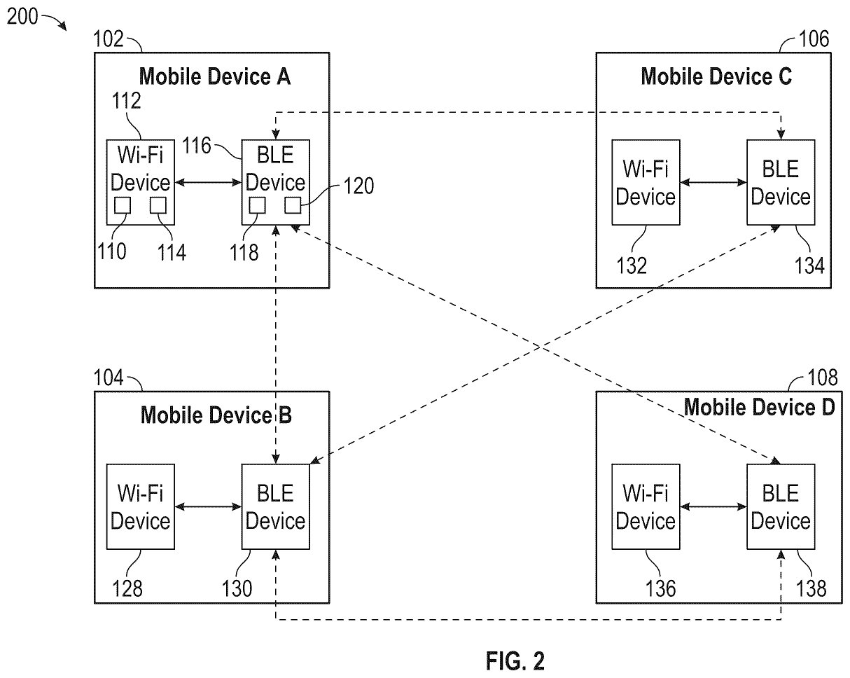

FIG. 2 depicts an example of a system 200 that includes the mobile devices of FIG. 1. The system 200 includes the mobile device A 102, the mobile device B 104, the mobile device C 106, and the mobile device D 108 of FIG. 1. These mobile devices were described above and, for conciseness, will not be described in detail again. The BLE devices form a local network, such as a mesh network.

Each Wi-Fi device sends its connectivity status to the corresponding BLE device of the mobile device. Each BLE device broadcasts that connectivity status to the other BLE devices in the mesh network. Each BLE device updates its node status list with the connectivity status information from the other mobile devices.

In this manner, each BLE device maintains a dynamic table or other data structure indicating which Wi-Fi devices are online.

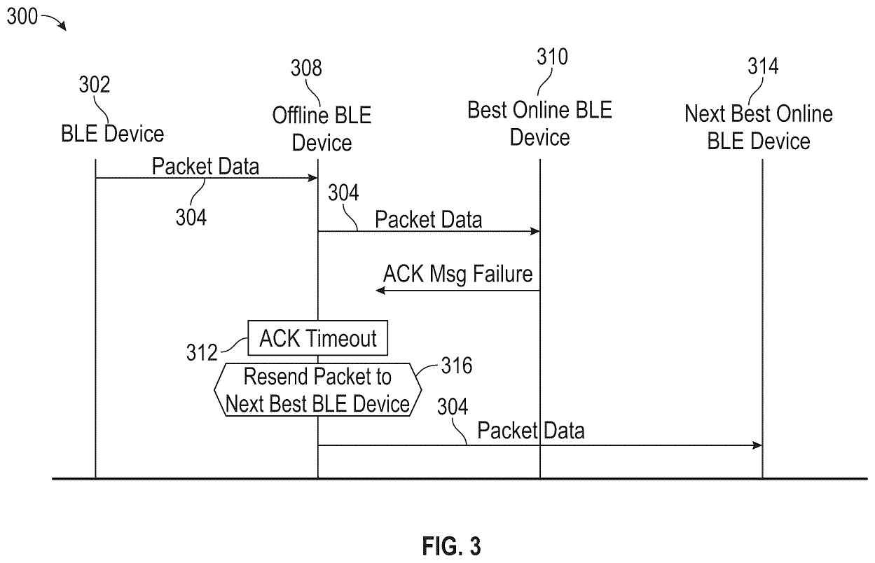

FIG. 3 depicts a sequence diagram 300 of an example of a redundancy technique to ensure reliable data transmission. The technique involves a backup strategy where if the primary BLE device (the closest online node) fails to acknowledge the receipt of data, the sending BLE device will then attempt to send the data to the best online BLE device and, if that fails, to the next best online BLE device. The “best online BLE device” and “next best online BLE device” may be based on signal strength and/or proximity.

In FIG. 3, a Wi-Fi device on a mobile device is offline. The Wi-Fi device transmits its data, e.g., analytics data, to the BLE device 302 on the mobile device, such as using UART. The BLE device 302 attempts to transmit the data 304 to another BLE device 308 on a different mobile device in the mesh network. However, the BLE device 308 is associated with a Wi-Fi device that is offline (“offline BLE device”).

Because the BLE device 308 is associated with a Wi-Fi device that is offline, the BLE device 308 attempts to send the data 304 to another BLE device 310 in the mesh network, which is referred to as the “best online BLE device” based on signal strength and/or proximity. That is, the processor of a first BLE device is configured for determining corresponding signal strengths of the active devices in the local network, and, in response to determining that a signal strength of a second BLE device is strongest in the local network, the processor of the first BLE device is configured for transmitting data to the second BLE device.

However, in intervening time, the mobile device associated with the BLE device 310 may have moved such that the BLE device 310 is no longer in the mesh network. The BLE device 308 awaits an acknowledgment signal from the BLE device 310 that the data 304 was received. In this case, the BLE device 308 does not receive an acknowledgment signal from the BLE device 310 and, as such, there is an acknowledgment timeout 312 at the BLE device 308.

After the acknowledgment timeout 312, the BLE device 308 successfully resends the data 304 to the next best online BLE device 316, namely BLE device 314, which is based on signal strength and/or proximity.

The redundancy described with respect to FIG. 3 ensures that even if one node fails or is temporarily unavailable, the data can still reach the internet via an alternative path within the BLE mesh network. This technique enhances the reliability of the network, particularly in dynamic environments where device availability and connectivity may frequently change.

In addition to the techniques described above, this disclosure is also directed to techniques for automatic and dynamic provisioning of devices in the local network, e.g., BLE devices in a mesh network. In conventional BLE mesh networks, BLE devices must be manually added to the network. However, the techniques of this disclosure allow for automatic and dynamic provisioning of BLE devices. This means that BLE devices may self-register and configure themselves without human intervention when they come online. This feature significantly simplifies the setup and maintenance of BLE mesh networks, making it particularly useful in dynamic environments where devices frequently go offline and come back online.

After a BLE device is flashed with application firmware, using various techniques of this disclosure, a BLE device provisions and configures itself when it powers up. The provisioning process may include the following:
1. Set unicast address. The unicast address is the BLE device's unique address within the mesh network. It is used to send and receive messages specifically addressed to this device. In some examples, each BLE device uses two consecutive unicast addresses. For instance, if a BLE device is configured with address 0x10, it will also access address 0x11. As such, it may be desirable in such examples to only use even numbers for the unicast address assignment during provisioning.
2. Set up security keys such as network, application, and device keys. The network key is used to identify the entire mesh network. Only devices that possess this key are allowed to interact with the network. The application key is used to identify a particular application within the network. For example, lighting elements may share one application, while audio elements may share another application. This may help partition devices within a single network into groups of devices that do not need to communicate with each other. The device key is used to uniquely identify each device. It is mainly used by the provisioner in scenarios where the devices are not self-provisioned.
3. Bind application key to model. In this step, the application key is bound to the model so the device can send/receive messages within its application.
4. Configure the model. The configuration step includes setting parameters relevant to the sending and receiving of messages such as subscription and publication addresses.

Each BLE device may use BLE mesh messages to communicate with the other BLE devices in the BLE mesh network. Each BLE device broadcasts the connectivity status of its corresponding Wi-Fi device to the entire mesh network. If a given BLE device receives a UART message from its Wi-Fi device indicating that the Wi-Fi device is now offline, then BLE device sends a packet data message to the nearest online node (BLE device) that it is aware of. Finally, once the packet data message is received by the destination node, that node sends an acknowledge message back to confirm the receipt of the message.

Once the BLE device receives status info from the Wi-Fi device, the BLE device sends out this information to all the BLE devices in the BLE mesh network. It does this by composing a Mesh Status Message.

Once the BLE device receives a packet data message from the Wi-Fi device, the BLE device forwards the packet data to the nearest online BLE device. In order to achieve this, the BLE device first finds the destination BLE device by finding the closest online BLE device in its local node list, then it sets the published address of the Mesh model to this destination node. Once the published address is set appropriately, the BLE device publishes a message to the destination node containing the packet data.

Once the destination node receives this message, the BLE device sends the received packet data to its Wi-Fi device via UART, and the Wi-Fi device uploads the packet data to the server. In parallel, the destination node will send back an Acknowledge message to the original BLE device to confirm that it received the packet data message.

When a BLE device receives a packet data message over the mesh network, the BLE device sends back an Acknowledge message (ACK) to the original BLE device to let it know it successfully received the packet data message. The original BLE device receives this message and proceeds to send any other messages it may have. If the original BLE device does not receive the ACK within a reasonable amount of time (such as 10 seconds), it will timeout. The original BLE device will attempt to send the message again, e.g., two more times, and if the target BLE device does not respond, the original BLE device removes the destination BLE device from its node list to prevent sending any more messages to it. After removing the last target BLE device, the original BLE device resends the message to the next best BLE device in its node list. If the ACK continues to timeout, the original RF repeats the above process until there are no more suitable BLE devices in its node list.

The BLE mesh messages may include several different pieces of metadata. For example, the following parameters may be desirable:
Source address. This parameter describes the unicast address of the BLE device that originally sent the packet that has been received.
Destination address. The destination address may be a unicast, group, or virtual address (depending on the type of address) that describes the intended recipient(s) of the message.
Time-to-live (TTL). Time-to-live is slightly different depending on whether the message is being sent or received. For messages that are being sent, TTL describes the maximum number of BLE devices that the message is allowed to travel through consecutively. For received messages, TTL describes the number of remaining hops for this message. For example, assume a message is sent with a TTL value of 5. To reach its destination, it jumps through two other nodes. Each node will decrement the TTL value as it passes along the message, so when the message is received by its destination, it will see a TTL value of 3.
Scanner Metadata. Parameters such as Advertisement address, RSSI, and Timestamp may be included.

Each BLE device may maintain a local node list. As the BLE device receives status messages from the other BLE devices in the mesh network, it will add or update the source address, status data, and TTL metadata for each received message to the node list. Each source address had its own entry in the list. In the process of adding each of these entries to the list, the BLE device ensures that the list is sorted first by online status, then by TTL in ascending order, so that the first entry in the list is the most online node with the highest TTL value.

The UART peripheral may be used by the BLE device to send and receive messages to and from the Wi-Fi device on the mobile device. For example, polling is used to send and receive messages to and from the Wi-Fi device. Once a full message has been received by the UART driver, an event is triggered to the Event Generator Unit (EGU) to process the message appropriately.

In the system, the Wi-Fi device and the BLE device communicate via UART. They may use predetermined message formats to send information back and forth. As an example, each message may contain one byte of opcode followed by up to 372 bytes of the payload. Desirable information transmitted this way includes the connectivity status of the Wi-Fi device and the Wi-Fi device's analytics data packets. The message may be encoded using Consistent Overhead Byte Stuffing (COBS) before transmission over UART and decoded when received by the other device.

Table 1 depicts an example of a message format:

TABLE 1

| Opcode | Padding | Payload |
|---|---|---|
| ← 1 byte | ← 3 byte → | ← 372 bytes → |

As seen above in Table 1, the message format includes opcode, e.g., one byte, padding, e.g., three bytes, and payload, e.g., 372 bytes.

Table 2 depicts an example of an opcode table:

TABLE 2

| Message Opcode | Value |
|---|---|
| Status | 0x1 |
| Packet Data | 0x2 |
| RTLS | 0x3 |
| Provision | 0x4 |
| Echo | 0x5 |
| Log | 0x6 |
| Reset | 0x7 |
| EmTag ID | 0x8 |
| DFU | 0x9 |

The lefthand column in Table 2 depicts the message opcodes, e.g., status, packet data, and the righthand column depicts the value of the opcode. Various examples of the message opcodes are described below.

The status message may contain 8 bytes of data in the payload. These bytes may contain one of two possible strings, either “online” or “offline”. This string describes the Wi-Fi connectivity status of the Wi-Fi device (whether it is offline or online). When the BLE device receives this message from the Wi-Fi device, the BLE device sends out this status information to the entire BLE mesh network.

The packet data message may have the payload fully populated, such as with 370 bytes of data. This data contains various analytics data of the mobile device. When the BLE device receives this message from the Wi-Fi device, the BLE device sends the packet data to the nearest online BLE device via the BLE mesh network.

An example of how data of a Real-Time Locating Systems (RTLS) message may be populated is shown below below in Table 3:

TABLE 3

| Byte | Data |
|---|---|
| 0 | Best Beacon Major MSB |
| 1 | Best Beacon Major LSB |
| 2 | Best Beacon Minor MSB |
| 3 | Best Beacon Minor LSB |
| 4 | Best Beacon RSSI |
| 5 | Best Beacon Battery Level |
| 6 | 2^{nd} Best Beacon Major MSB |
| 7 | 2^{nd} Best Beacon Major LSB |
| 8 | 2^{nd} Best Beacon Minor MSB |
| 9 | 2^{nd} Best Beacon Minor LSB |
| 10 | 2^{nd} Best Beacon RSSI |
| 11 | 2^{nd} Best Beacon Battery Level |
| 12 | BLE device emtag Major |
| 13 | BLE device emtag Minor |

The provision message may include a 2 byte unicast address. The BLE device self-provisions and assigns itself this unicast address.

The echo message may include a 372 byte payload. The BLE device may echo whatever payload it receives directly back to UART. This message may be used to verify the basic functionality of the firmware.

The log message may include a full 372 byte payload. The BLE device may log out debugging prints to the UART to assist in debugging when the BLE device is not accessible via J-Link, for example. The payload may include a null-terminated string up to 371 characters long.

The reset message does not carry any payload. Its sole purpose is to reset the node before re-provisioning.

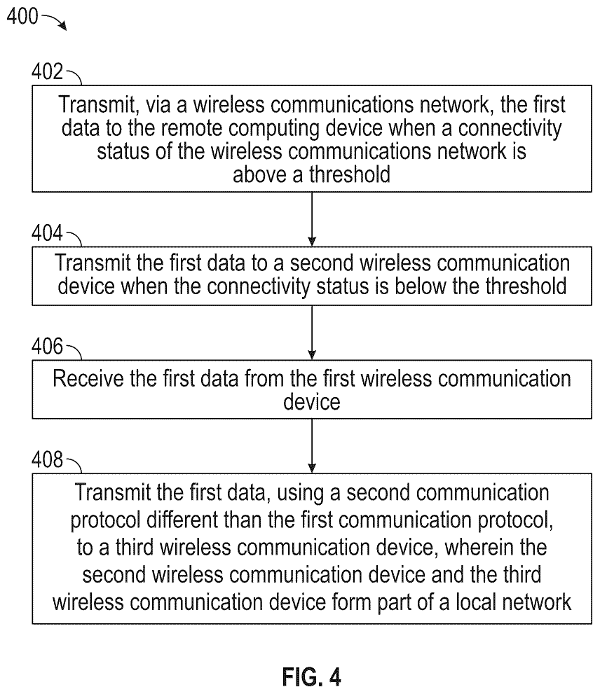

FIG. 4 is a flow diagram of an example of a method 400 of operating a mobile cart in a hospital environment, where the mobile cart includes a first wireless communication device including a processor, the first wireless communication device configured for transmitting first data using a first communication protocol to a remote computing device using a wireless communications network. At block 402, the method includes transmitting, via the wireless communications network, the first data to the remote computing device when a connectivity status of the wireless communications network is above a threshold. For example, the processor of a Wi-Fi device, such as the processor 112 of the Wi-Fi device 110 of the mobile device A 102 of FIG. 1 is configured for transmitting, via the wireless communications network 124, the data to the remote computing device 122 when the connectivity status of the wireless communications network 124 is above a threshold.

At block 404, the method includes transmitting the first data to a second wireless communication device when the connectivity status is below the threshold. For example, when the connectivity status of the wireless communications network is below the threshold, the mobile device is configured for transmitting the data to a second wireless communication device of the mobile device, e.g., to the BLE device 116 using UART, when the connectivity status is below the threshold.

At block 406, the method includes receiving the first data from the first wireless communication device. For example, the processor 118 of the BLE device 116 is configured for receiving the data from the Wi-Fi device 110.

At block 408, the method includes transmitting the first data, using a second communication protocol different than the first communication protocol, to a third wireless communication device, where the second wireless communication device and the third wireless communication device form part of a local network. For example, the processor 118 of the BLE device 116 is configured for transmitting the data to another BLE device in the mesh network. In the example shown in FIG. 1, the BLE device 116 is in communication with the BLE device 130 of the mobile device B 104.

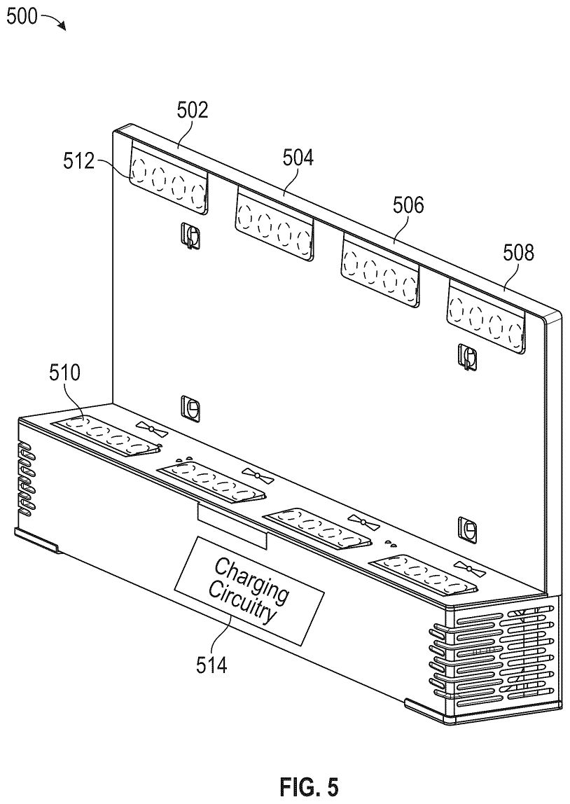

FIG. 5 is a perspective view of an example of a charging station 500 that may implement various techniques of this disclosure. The charging station depicted in FIG. 5 includes 4 bays, shown as bay 502, bay 504, bay 506, and bay 508. Each bay is configured for receiving a corresponding battery, such as the hot-swappable batteries of FIG. 1, and fully recharging the battery via charging circuitry 514. For example, the bay 502 is configured for receiving the hot-swappable battery 156 of the mobile device A 102 the mobile device A 102 of FIG. 1. In other examples, the charging station 500 includes fewer than 4 bays or more than 4 bays.

Each bay includes sets of contacts 510, 512 configured for electrically coupling with corresponding sets of contacts associated with a hot-swappable battery. A set of contacts may include individual contacts for a positive terminal, a negative terminal, battery identification, battery temperature, and battery communication, for example.

The charging stations may be strategically placed throughout a facility to provide convenient access and ensure continuous operational efficiency. The charging stations are capable of connecting to the local network, such as the BLE mesh network described above, which is designed to collect location and sensor data from each connected device, including the charging stations.

The processor of the BLE device may be configured for requesting and receiving various battery data, such as battery capacity and usage information, from the hot-swappable battery via their BLE antennas. For example, the processor 118 of the BLE device 116 of the mobile device A 120 of FIG. 1 transmits, via antenna 172, a request for battery data of the hot-swappable battery 156. The antenna 158 of the hot-swappable battery 156 receives the request, a processor associated with the hot-swappable battery 156 determines the requested information, and the processor transmits the information via the antenna 158 to the antenna 172 of the BLE device 116. The data transmitted by the hot-swappable batteries may include, but is not limited to, battery capacity and usage status.

A processor associated with the BLE mesh network, such as the processor 118 of the BLE device 116, may calculate the relative distances between mobile devices, such as the mobile device A 102, the mobile device B 104, the mobile device C 106, and the mobile device D 108, and nearby batteries or charging stations. When the battery capacity of a mobile device drops below a threshold, the processor of the BLE device of the mobile device may be configured for determining a location of a nearest available charger or available hot-swappable battery with higher remaining capacity.

The processor of the BLE device may be further configured for transmitting, such as to the Wi-Fi device of the mobile device, data representing the location of the nearest available charger or available hot-swappable battery with higher remaining capacity. The Wi-Fi device may be configured for displaying, such as on a display of the mobile device, the location of the nearest available charger or available hot-swappable battery with higher remaining capacity. In response, a user may move the mobile device to the nearest available charger to replace its battery or batteries.

### VARIOUS NOTES

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A mobile cart for use in a hospital environment, the mobile cart comprising:
a first wireless communication device including a processor, the first wireless communication device configured for transmitting first data using a first communication protocol to a remote computing device using a wireless communications network, wherein the processor is configured for:
transmitting, via the wireless communications network, the first data to the remote computing device when a connectivity status of the wireless communications network is above a threshold; and
transmitting the first data to a second wireless communication device when the connectivity status is below the threshold; and
the second wireless communication device includes a processor configured for:
receiving the first data from the first wireless communication device; and
transmitting the first data, using a second communication protocol different than the first communication protocol, to a third wireless communication device, wherein the second wireless communication device and the third wireless communication device form part of a local network.

2. The mobile cart of claim 1, wherein the third wireless communication device is in communication with a fourth wireless communication device, wherein the fourth wireless communication device includes a processor configured for transmitting the first data using the first communication protocol to the remote computing device using the wireless communications network.

3. The mobile cart of claim 2, wherein the processor of the second wireless communication device is configured for:
receiving, via the local network, a connectivity status of the fourth wireless communication device.

4. The mobile cart of claim 3, wherein the processor of the second wireless communication device is configured for:
storing the connectivity status of the first wireless communication device; and
storing the connectivity status of the fourth wireless communication device.

5. The mobile cart of claim 2, wherein the third wireless communication device and the fourth wireless communication device are positioned on another mobile cart.

6. The mobile cart of claim 1, wherein the first wireless communication device is a Wi-Fi device.

7. The mobile cart of claim 1, wherein the second wireless communication device is a Bluetooth Low Energy (BLE) device.

8. The mobile cart of claim 1, wherein the local network is a mesh network.

9. The mobile cart of claim 8, wherein the mesh network is configured to provide real-time location services.

10. The mobile cart of claim 1, wherein the processor of the first wireless communication device is configured for:
determining the connectivity status; and
transmitting the connectivity status to the second wireless communication device.

11. The mobile cart of claim 10, wherein the processor of the second wireless communication device is configured for:
transmitting, via the local network, the connectivity status to the third wireless communication device.

12. The mobile cart of claim 1, wherein the first data includes analytics data of the mobile cart.

13. The mobile cart of claim 12, wherein the analytics data includes battery data and telemetry data.

14. The mobile cart of claim 1, wherein the second wireless communication device is configured for:
receiving a corresponding connectivity status from wireless communication devices in the local network; and
storing, based on the connectivity status, data representing active devices in the local network.

15. The mobile cart of claim 14, wherein the processor of the second wireless communication device is configured for determining corresponding signal strengths of the active devices in the local network, and
wherein, in response to determining that a signal strength of the third wireless communication device is strongest in the local network, the processor of the second wireless communication device is configured for transmitting the first data to the third wireless communication device.

16. The mobile cart of claim 1, wherein the processor of the second wireless communication device is configured for performing a provisioning process of the second wireless communication device without human intervention.

17. The mobile cart of claim 1, wherein the processor of the second wireless communication device is configured for performing the provisioning process of the second wireless communication device without human intervention is configured for:
setting a unicast address of the second wireless communication device.

18. The mobile cart of claim 17, wherein setting the unicast address of the second wireless communication device includes setting two consecutive addresses.

19. The mobile cart of claim 16, wherein performing the provisioning process includes:
setting a network key specific to the local network.

20. The mobile cart of claim 1, wherein the processor of the first wireless communication device is configured for transmitting the first data to the second wireless communication device using a third communication protocol, and wherein the third communication protocol is different from both the first communication protocol and the second communication protocol.
